(19) United States
(12) Patent Application Publication
(10) Pub. No.: US 2021/0287543 A1
(43) Pub. Date: Sep. 16, 2021

(54) METHODS, APPARATUS AND COMPUTER-READABLE MEDIUMS FOR NOTIFICATION OF VEHICULAR ACCIDENTS

(71) Applicant: Telefonaktiebolaget LM Ericsson (publ), Stockholm (SE)

(72) Inventor: Athanasios KARAPANTELAKIS, (US)

(21) Appl. No.: 16/332,609

(22) PCT Filed: Sep. 12, 2016
(86) PCT No.: PCT/EP2016/071429

§ 371 Date: Mar. 12, 2019

(51) Int. Cl. G08G 1/16; G08G 1/09; G08G 1/056; G08B 25/01; G08B 25/10; G08G 1/0967

(52) U.S. Cl. CPC G08G 1/162; G08G 1/091; G08G 1/096791; G08B 25/016; G08B 25/10; G08G 1/056

(57) ABSTRACT

Methods, apparatus and computer-readable mediums are provided in a wireless network for the early notification of a vehicular accident to wireless devices in the vicinity of the accident. A method comprises, in a network node of a wireless telecommunication system, responsive to reception of a distress signal by a radio access node, the distress signal generated automatically by a vehicle involved in an accident, initiating transmission, by the radio access node, of a warning signal containing an indication of the accident to one or more wireless devices.

### TECHNICAL FIELD

Examples of the present disclosure relate to methods, apparatus and computer program products for notification of vehicular accidents, and particular to methods, apparatus and computer program products for notification of vehicular accidents over a wireless communications network.

### BACKGROUND

Current driver-assistance systems in vehicles focus on two main areas. First, a number of systems have been developed in recent years to provide additional safety in the immediate vicinity of the vehicle (e.g., lane departure warning, auto-braking in the presence of an obstruction in the road, etc.). Second, satellite navigation systems (and analogous applications on mobile electronic devices) have been developed to provide real-time feedback on the traffic conditions that might be experienced travelling along a particular road. For example, Google® Maps operates by receiving data packets transmitted by users, containing their location and speed, collating that information to determine the average speed on particular roads, and then transmitting the information back to users to enable better route planning, etc.

The latter systems can enable shorter travel times through appropriate route planning to avoid roads on which the average speed is low. However, a large number of users is required in order for the average speed to be a valid (i.e. reliable) estimate. Such numbers may not always be available. Also, the amount of time required to obtain such data may be relatively long, meaning the system may have difficulties in reacting quickly to unexpected events such as road-traffic accidents.

### SUMMARY

In one aspect of the present disclosure, there is provided a method in a network node of a wireless telecommunication system, the method comprising: responsive to reception of a distress signal by a radio access node, the distress signal generated automatically by a vehicle involved in an accident, initiating transmission, by the radio access node, of a warning signal containing an indication of the accident to one or more wireless devices.

In another aspect, there is provided a network node for a wireless telecommunication system, the network node comprising: processor circuitry; and a computer-readable medium coupled to the processor circuitry and storing code which, when executed by the processor circuitry, causes the network node to: responsive to reception of a distress signal by a radio access node, the distress signal being generated automatically by a vehicle involved in an accident, initiate transmission, by the radio access node, of a warning signal containing an indication of the accident to one or more wireless devices.

In a further aspect, there is provided a computer-readable medium storing code which, when executed by processor circuitry of a network node, causes the network node to: responsive to reception of a distress signal by a radio access node, the distress signal being generated automatically by a vehicle involved in an accident, initiate transmission, by the radio access node, of a warning signal containing an indication of the accident to one or more wireless devices.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic drawing of a wireless network according to embodiments of the disclosure;

FIG. 2 is a signalling diagram of a method according to embodiments of the disclosure;

FIG. 3 is a signalling diagram of a method according to further embodiments of the disclosure;

FIG. 4 is a flow chart of a method according to embodiments of the disclosure;

FIG. 5 is a schematic diagram of a network node according to embodiments of the disclosure; and

FIG. 6 is a schematic diagram of a network node according to further embodiments of the disclosure.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Although the terms “wireless device” or “terminal device” may be used in the description, it is noted that these terms encompass other terms used to denote wireless devices, such as user equipment (UE). It should be understood by the person skilled in the art that “UE” is a non-limiting term comprising any mobile or wireless device or node equipped with a radio interface allowing for at least one of: transmitting signals in uplink (UL), receiving and/or measuring signals in downlink (DL), and transmitting and/or receiving signals in a D2D/sidelink mode. A wireless device herein may comprise a UE (in its general sense) capable of operating or at least performing measurements in one or more frequencies, carrier frequencies, component carriers or frequency bands. It may be a “UE” operating in single- or multi-radio access technology (RAT) or multi-standard mode. As well as “wireless device” or “UE”, the terms “mobile device” and “terminal device” may be used interchangeably in the description, and it will be appreciated that such a device does not necessarily have to be ‘mobile’ in the sense that it is carried by a user. Instead, the term “mobile device” encompasses any device that is capable of communicating with communication networks that operate according to one or more mobile communication standards, such as the Global System for Mobile communications, GSM, Universal Mobile Telecommunications System (UMTS), Long-Term Evolution, LTE, etc.

It should be noted that use of the term “radio access node” as used herein can refer to a base station, such as an eNodeB, a network node in the RAN responsible for resource management, such as a radio network controller (RNC), or, in some cases, a core network node, such as a mobility management entity (MME), a ProSe function (ProSe-F) node or a ProSe Application Server. It may also refer to an access point (AP) implementing IEEE 802.11 standards. The term “network node” encompasses radio access nodes, and also nodes within or accessible via a core network. For example, a network node may comprise a server that is located remote from a radio access node, but receives data signals from the radio access node and provides control signals for the radio access node. This latter example reflects the increasing trend in telecommunications systems for functionality to be removed to servers operating in “the cloud”.

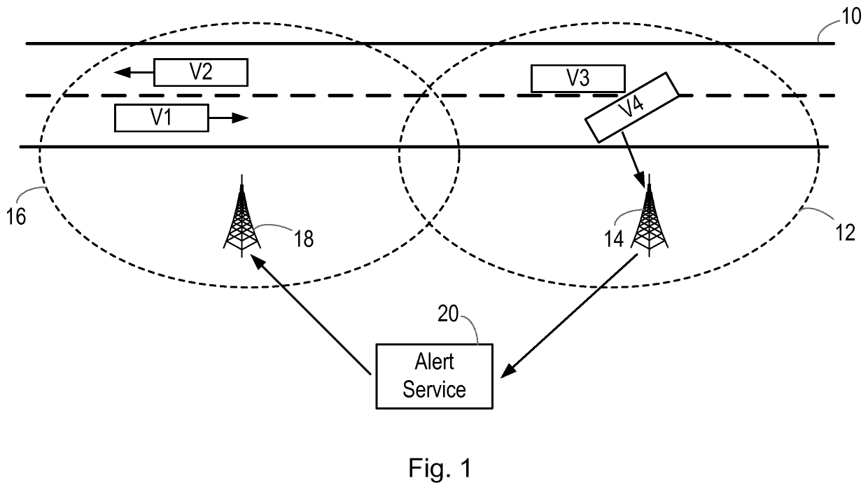

FIG. 1 shows a schematic drawing of a wireless network according to embodiments of the disclosure.

A number of vehicles V1, V2, V3 and V4 are moving on a road 10. Vehicles V3 and V4 are involved in a road-traffic accident. Vehicle V1 is moving towards the accident, but currently some distance away from it. Vehicle V2 is also some distance away from the accident, but moving away from it.

FIG. 1 also shows a wireless cellular communications network (or a portion of a wireless cellular communications network), through which the road 10 runs. The cellular network may at least partly be based on radio access technologies such as e.g. 3GPP Long Term Evolution (LTE), LTE-Advanced, Evolved Universal Terrestrial Radio Access Network (E-UTRAN), Universal Mobile Telecommunications Service (UMTS), Global System for Mobile (GSM)/Enhanced Data rate for GSM Evolution (GSM/EDGE), Wideband Code Division Multiple Access (WCDMA), Worldwide Interoperability for Microwave Access (WiMax), Ultra Mobile Broadband (UMB), Evolved Universal Terrestrial Radio Access (E-UTRA), Universal Terrestrial Radio Access (UTRA), GSM EDGE Radio Access Network (GERAN), 3GPP2 CDMA technologies e.g. CDMA2000 1×RTT, High Rate Packet Data (HRPD) and IEEE 802.11 just to mention some options. The network may be suitable for providing radio communications meeting one or more of the criteria established by the Next Generation Mobile Networks Alliance for the 5th generation of mobile telecommunications standards.

The network comprises a first cell 12, which is served by a first radio access node 14, and a second cell 16 which is served by a second radio access node 18. The radio access nodes 14, 18 may be referred to as e.g. base stations, NodeBs, evolved NodeBs (eNB, or eNodeB), base transceiver stations, access points (i.e. implementing IEEE 802.11x wireless technology), base station routers, radio base stations (RBSs), macro base stations, micro base stations, pico base stations, femto base stations, Home eNodeBs, relays and/or repeaters, beacon devices or any other network node configured for communication with wireless devices over a wireless interface, depending e.g. on the radio access technology and terminology used.

In the illustration, the cells 12, 16 are sufficiently close to one another that a direct wireless interface can be established between the radio access nodes, i.e. the radio access node 14 is able to communicate with the radio access node 18 directly, without passing through the core network. In the LTE standard, this interface is called the X2 interface. Such an interface may be conventionally used for handover of a wireless device that moves from one cell to another.

Each radio access node 14, 18 may comprise, or have access to, a neighbour relation table (NRT) for each of their respective cells 12, 16. For a particular cell (target cell), the NRT comprises a list of cells that neighbour the target cell. Each entry in the NRT may comprise an identifier for the neighbour cell (e.g. physical cell identity (PCI), globally unique cell identifier (CGI), etc), and may also comprise one or more attributes for the neighbour cell, such as whether the neighbour cell is to be used for handover processes, whether messages can be sent to the neighbour cell over a direct interface (e.g. X2), or whether the entry can be deleted by the radio access node itself.

The NRT for each cell may be established at the time of installation of the radio access node 14, 18, and then maintained and updated by an operator over time, as conditions change and cells are created or replaced. Alternatively, the radio access nodes 14, 18 may utilize an automatic neighbour relations (ANR) function to discover the cells around them, populating and updating the NRT automatically. For example, a radio access node may request wireless devices in its respective cell to carry out measurements of neighbouring cells and report the results back to the radio access node so that the NRT can be updated.

In the illustration, the two radio access nodes 14, 18 (and the cells 12, 16 which they serve) may be termed “neighbouring”, in that they are geographically proximal and have at least some overlapping radio coverage. Note that neighbouring cells may abut each other and overlap to an extent (as in the illustration), or merely be sufficiently close that one or more wireless devices in one cell are able to receive wireless signals from another cell.

The wireless cellular network further comprises an alert service 20 in communication with the radio access nodes 14, 18. Further discussion regarding the operation of the alert service 20 will be provided below. However, the service 20 may be implemented in a core network of the wireless network or in a radio access network of the wireless network. In the latter case, the alert service 20 may be implemented directly in one or more of the radio access nodes 14, 18 (e.g. in the radio access node 14).

Vehicle V4, which was involved in the accident, comprises an in-vehicle safety system (not illustrated) operative to generate and transmit an emergency distress signal in the event that the vehicle V4 is involved in a road accident. For example, the safety system may comply with one or more standards such as e-Call or ERA-GLONASS, or utilize wireless vehicle services such as Onstar. Upon detection that the vehicle has been involved in an accident (or, in some cases, upon manual activation by a user of the vehicle), the safety system transmits a wireless message containing information relating to the accident. For example, the wireless message may comprise the location of the vehicle V4. The system may initiate an emergency call carrying voice and/or data (including location data) directly to the nearest Public Safety Answering Point (i.e. an emergency call centre) to determine whether rescue services should be dispatched to the accident location.

The safety system may comprise processing circuitry that is operatively coupled to a plurality of sensors distributed around the vehicle. The sensors may include one or more of: acceleration sensors, arranged to detect acceleration levels indicative of an accident (i.e. acceleration that exceeds a predetermined threshold); airbag deployment sensors that trigger upon deployment of an airbag in the vehicle; speed sensors, arranged to detect the speed of the vehicle; location sensors, arranged to detect the geographical position of the vehicle (e.g. through GPS signals, GLONASS, or other positioning services); seat sensors, arranged to detect the presence of passenger(s) in the vehicle; and seat belt sensors, arranged to detect the use of seat belts by passengers within the vehicle.

A number of these sensors may be found as standard in modern vehicles. For example, it is well known that vehicles comprise a mechanism for determining the vehicle's speed (and display of that speed via a speedometer). Vehicles with airbag systems will also comprise one or more acceleration sensors (or, specifically deceleration sensors) so as to trigger deployment of the airbag upon sudden deceleration that is indicative of an accident.

Others of the sensors may be dedicated to the safety system. For example, vehicles may not be provided with a location sensor, and therefore this may be provided by the safety system itself.

The safety system may thus comprise processing circuitry that is operatively coupled to one or more existing sensors within the vehicle (that is, sensors that are provided for other, additional purposes than the safety system), and/or dedicated sensors (that is, sensors that are provided primarily for use with the safety system).

The safety system may further comprise a wireless modem coupled to the processing circuitry, operative to transmit wireless signals generated by the processing circuitry, and to receive wireless signals transmitted by a wireless network and pass those signals to the processing circuitry to be processed. For example, the wireless modem may comprise one or more antennas, and transceiver circuitry coupled to the antenna(s), configured to modulate signals for transmission by the antenna(s) and to demodulate signals received by the antenna(s).

In the event of a road traffic accident, the processing circuitry determines that an accident has occurred through data received from the plurality of sensors. The processing circuitry may determine that an accident has occurred if one of the sensors satisfies an accident condition (e.g. one or more airbags are deployed, the acceleration of the vehicle exceeds a threshold, etc).

Upon detection of the accident, the processing circuitry automatically generates a wireless distress signal and transmits that distress signal using the wireless modem to the radio access node 14. The distress signal may comprise data related to the accident, such as one or more of: the location of the vehicle V4; a time (and date) of the accident; a vehicle type of the vehicle V4 (e.g. car, motorbike, van, lorry, public transport vehicle, etc); a propulsion type of the vehicle V4 (e.g. petrol, diesel, electric, hydrogen, natural gas, etc); a number of occupants of the vehicle V4 at the time of the accident; an indication of the direction of travel of the vehicle V4 at the time of the accident; and an indication of a speed of travel of the vehicle V4 at the time of the accident.

The distress signal may initiate a voice and/or data call to the nearest Public Safety Answering Point through the radio access node 14 (and via other services of the cellular network not illustrated, such as the core network, etc). For example, the information contained in the distress signal may be automatically forwarded to the public safety answering point.

According to embodiments of the disclosure, the alert service 20 is operative to intercept the wireless distress signal and, based on the contents of the distress signal, initiate the transmission of warning signals to wireless devices within the vicinity of the accident. For example, the alert service 20 may be operable to initiate the transmission of warning signals to wireless devices within the cell 12 where the accident took place. In addition, or alternatively, the alert service 20 may be operable to initiate the transmission of warning signals to wireless devices within one or more cells that neighbour the cell 12 where the accident took place (such as the cell 16).

The warning signals may themselves contain information relating to the accident (e.g. obtained from the contents of the distress signal), such as one or more of: the location of the vehicle V4; a time (and date) of the accident; a vehicle type of the vehicle V4 (e.g. car, motorbike, van, lorry, public transport vehicle, etc); a propulsion type of the vehicle V4 (e.g. petrol, diesel, electric, hydrogen, natural gas, etc); a number of occupants of the vehicle V4 at the time of the accident; an indication of the direction of travel of the vehicle V4 at the time of the accident; and an indication of a speed of travel of the vehicle V4 at the time of the accident.

The warning signals may be transmitted (e.g. broadcasted) to all wireless devices within the cells 12, 16, or only a subset of those devices. For example, the alert service 20 may initiate transmission of warning signals only to wireless devices embedded within vehicles or wireless devices travelling within vehicles (e.g. travelling at relatively high speed). The alert service 20 may initiate transmission of warning signals only to wireless devices that are near, or moving towards the location of the accident.

Further, the alert service 20 may combine one or more of these criteria to initiate transmission of warning signals to different devices in different cells. For example, the alert service 20 may initiate transmission of warning signals to all wireless devices within the cell 12 where the accident took place, and, in neighbouring cells, only to devices travelling towards the location of the accident.

Note that, by intercepting the wireless distress signal, the alert service does not prevent the distress signal from reaching its intended destination (e.g. the nearest public safety answering point). Rather, the distress signal continues to be forwarded to the public safety answering point regardless of its interception by the alert service 20, so that the emergency services are informed of the accident and the safety system operative in the vehicle V4 fulfils its function. The distress signal may even be forwarded to the public safety answering point with substantially no delay, i.e. relative to the time taken to forward the signal without interception.

Following its transmission by the safety system within vehicle V4, the distress signal may be transmitted between multiple nodes of the network on the journey to the public safety answering point. For example, the distress signal is received by the radio access node 14 serving the cell 12 in which the accident took place, and may then be forwarded to the public safety answering point via at least one other node (and typically multiple nodes). The at least one other node may comprise a node in the core network of the cellular network. At each node, the distress signal may be stored temporarily within a buffer memory before its onward transmission to the next node. Thus, the alert service may be operable, in a particular node or in multiple nodes, to analyse the contents of the buffer memory and determine the presence of a distress signal. In this way, the distress signal can be intercepted and its contents discerned, without interrupting the progress of the distress signal towards its intended destination. Alternatively, one of more of the nodes in the network (such as the radio access node 14 itself) may be operable to detect the reception of a distress signal and to relay the distress signal to the alert service 20 in addition to its intended destination.

Note that networks meeting IEEE 802.11 standards (i.e. where the radio access nodes are APs) do not generally contain cells. Nonetheless, even under these standards, each AP provides coverage within a certain geographical area defined by the transmit strength of the AP. In embodiments utilizing IEEE 802.11 standards, therefore, the “cells” 12, 16 may be considered as respective areas of coverage of the radio access nodes 14, 18. For convenience, however, the term “cell” will be used herein.

Further, IEEE 802.11 standards do not generally have a concept of “neighbouring” cells or devices, and thus conventional APs do not possess or have access to NRTs. According to embodiments, however, respective NRTs may nonetheless be defined for APs. NRT functionality may be implemented within each AP, or “over the top”, i.e. using a separate node that implements the NRT functionality for one, multiple or all APs within a network. For example, such NRTs may be established at the time of installation of the APs 14, 18, and then maintained and updated by an operator over time based on the operator's knowledge or measurement of the surrounding network nodes. In case the network supports Fast Basic Service Set (BSS) Transition protocol (FT) for handover between APs (IEEE 802.11r-2008) and neighbour discovery as specified in IEEE 802.11k-2008, then an AP can construct an NRT itself, using one or more of: neighbour reports and beacon reports. As IEEE 802.11 networks do not contain cells, the NRTs in this instance may contain an indication of neighbouring APs rather than cells (such as unique identifiers for the AP, e.g. an IP address, etc).

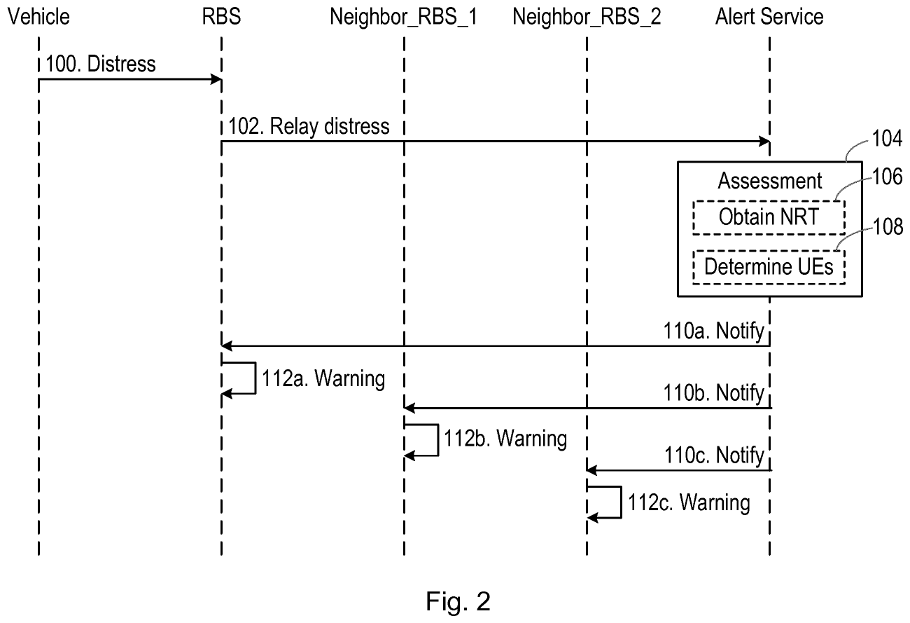

FIG. 2 is a signalling diagram showing the distress signal and warning signal transmission and processing according to embodiments of the disclosure. In relation to FIG. 1, the “Vehicle” is the vehicle comprising a safety system as described above, which has been involved in an accident, i.e. vehicle V4; the “RBS” is the radio access node or radio base station serving the cell in which the accident took place, i.e. radio access node 14. Neighbour_RBS_1 and Neighbour_RBS_2 are radio access nodes or radio base stations serving cells that neighbour the cell in which the accident took place, i.e. radio access node 18.

In the illustrated embodiment, the alert service 20 is implemented by one or more nodes in the wireless network, such as one or more nodes in the core network of the wireless network.

In step 100, the vehicle V4 is involved in a road accident, and the safety system within the vehicle detects the accident and automatically transmits a distress signal, as described above. In some cases, the safety system may allow a user of the vehicle to manually activate the system and initiate transmission of a distress signal, e.g. if the collision detection system fails for some reason, or if another emergency (other than an accident) warrants a distress signal.

The distress signal may comply with one or more standards such as e-Call or ERA-GLONASS, or utilize wireless vehicle services such as Onstar. The distress signal may contain information relating to the accident. For example, the wireless message may comprise the location of the vehicle V4. The location may be provided in a <latitude, longitude> tuple format. The system may initiate an emergency call carrying voice and/or data (including location data) directly to the nearest Public Safety Answering Point (i.e. an emergency call centre) to determine whether rescue services should be dispatched to the accident location.

The distress signal may comprise further data related to the accident, such as one or more of: a time (and date) of the accident; a vehicle type of the vehicle V4 (e.g. car, motorbike, van, lorry, public transport vehicle, etc); a propulsion type of the vehicle V4 (e.g. petrol, diesel, electric, hydrogen, natural gas, etc); a number of occupants of the vehicle V4 at the time of the accident; an indication of the direction of travel of the vehicle V4 at the time of the accident; and an indication of a speed of travel of the vehicle V4 at the time of the accident.

In step 102, the radio access node 14 receives the distress signal and relays it to the alert service 20.

As described above, the alert service 20 may intercept the distress signal in a number of different ways. For example, the alert service 20 may receive a duplicate of the distress signal from the radio access node 14, with another distress signal being forwarded to a public safety answering point (for example). Alternatively, the alert service 20 may be implemented within one or more network nodes that receive the distress signal on the journey to its destination. Thus, the relayed distress signal shown in step 102 may be a duplicate signal (i.e. a dedicated copy for the alert service) or the only copy of the distress signal.

In step 104, the alert service 20 carries out an assessment of the distress signal, based on the information contained within.

As part of the assessment, the alert service 20 may determine the severity of the accident based on one or more parameters contained within the distress signal and one or more predetermined rules. The predetermined rules for determining the severity of the accident may also be defined in accordance with the needs of the operator. For example, the speed of the vehicle at the time of the accident may be used to determine the severity of the accident, with higher speeds leading to relatively higher severity and vice versa. The vehicle type may be used to determine the severity. For example, if the accident involves a large vehicle, such as a truck or a bus, the accident may automatically be deemed highly severe. Those skilled in the art will appreciate that many alternative approaches may be used and the present disclosure is not limited to any particular one. Indeed, in some embodiments, the alert service may treat each distress signal equally (i.e. without determining the severity of the accident).

The alert service 20 may additionally base the assessment on contextual information received from one or more third parties. For example, the alert service 20 may obtain weather information for the accident location from a third-party weather service. The alert service 20 may obtain map data for the accident location, so as to determine the road on which the accident occurred, and/or relevant nearby buildings and structures.

Optionally, in step 106, the alert service 20 obtains the NRT of the radio access node that received the distress signal, i.e., the radio access node serving the cell in which the accident took place (radio access node 14), in order to determine the cells that neighbour the cell in which the accident took place. The NRT of the radio access node may be stored in the radio access node itself (in which case the alert service may contact the radio access node for a copy of the NRT), and/or in another node in the network (in which case the alert service 20 contacts the relevant node for a copy of the NRT).

Note that step 106 will generally not be required for embodiments in which wireless devices served by neighbour cells are not warned of the accident, e.g. because that functionality is not desired, or because the severity of the accident does not warrant it.

Optionally, in step 108, the alert service 20 may determine which wireless devices (that is, UEs) should receive a warning signal. For example, in one embodiment, all wireless devices in the cell 12 (that is, the cell where the accident took place) receive a warning signal. The alert service 20 may determine that all wireless devices in neighbouring cells should also receive a warning signal. Thus the warning signal may effectively be broadcasted to all wireless devices in the cell or cells. In this way, computational complexity in the alert service 20 is reduced, at the expense of increased usage of network resources (i.e. in sending warning signals to every wireless device within a particular cell or cells).

In other embodiments, only a subset of the wireless devices in the cell 14 (and potentially neighbouring cells) may be selected to receive warning signals. The alert service 20 may establish a multicast group for the subset of devices, and initiate transmission of a warning signal to the multicast address associated with the multicast group.

For example, those wireless devices that are integrated within vehicles may be identified and selected to receive warning signals. The international mobile station equipment identities (IMEIs) in the modems of vehicles are typically correlated to specific ranges of international mobile subscriber identities (IMSIs) that are unique to the manufacturers of vehicles. The alert service 20 may therefore be able to identify such vehicular wireless devices through communications with a mobility management entity (MME), in LTE embodiments, or similar devices in other network specifications, and initiating transmission (e.g. through multicast) to IMSIs that are associated with vehicle manufacturers.

In a further embodiment, the alert service 20 may initiate transmission of warning signals only to those devices that are integrated within vehicles and are travelling towards the location of the accident. Vehicular wireless devices may be identified as described above, by using IMSIs associated with vehicle manufacturers. In order to identify the particular vehicles that are travelling towards the location of the accident, the alert service 20 may obtain data relating to the location of the vehicular wireless devices, as well as their direction of travel.

Multiple different methods may be used in order to determine the location of a wireless device. For example, the alert service 20 may initiate a triangulation process in which multiple radio access nodes (e.g. three or more) determine the strength of signals received from the wireless device and thus triangulate the device's location. Alternatively, the wireless devices may be required to report their location (determined using GPS, GLONASS, or any other geographical location service) to the network.

Similarly, multiple different methods may be used in order to determine the direction of travel of a wireless device (as well as its speed). For example, the wireless devices may be required to report their direction of travel and/or speed (determined using GPS, GLONASS or any other geographical location service) to the network. Alternatively, the alert service 20 may determine the direction of travel by obtaining and analysing the record of connections made by the device to the network. That is, as the vehicular device moves through the network, it will pass multiple radio access nodes, connecting to and disconnecting from each node as the conditions for handover are fulfilled. The alert service 20 may obtain a record of the radio access nodes to which the device has connected, and so determine, in conjunction with data concerning the geographical location of each radio access node, the direction of travel of the device.

Note that steps 106 and 108 may be dependent upon the severity of the accident (in embodiments where the severity is determined by the alert service 20). For example, if the severity is low, or below a threshold, the alert service 20 may determine that only those devices in the immediate vicinity of the accident (i.e. in the same cell as the accident) need to be warned. If the severity is found to be particularly low (e.g. such that risk to disruption is also low), in some embodiments the alert service 20 may determine that no further action is required, at least with regard to warning other users in the vicinity of the accident. If the severity is found to be moderate, the alert service 20 may determine that warning signals should be sent only to wireless devices in the immediate vicinity of the accident (e.g. in the cell in which the accident occurred). If the severity is found to be high, the alert service 20 may determine that wireless devices in the cell in which the accident occurred and wireless devices in neighbouring cells should receive warning signals. The levels of severity and the alert service response to them may be defined in accordance with the needs of the network operator.

Once the distress signal has been assessed in step 104, the alert service 20 notifies the radio access nodes for the appropriate cells by formulating and transmitting a notification message in step 110. For example, in the illustrated embodiment, it is determined that devices within the cell in which the accident occurred, as well as each of the neighbouring cells, should be warned of the accident. Thus separate notification messages are sent to the radio access node that received the distress signal from the vehicle (RBS, in step 110a); as well as the neighbouring radio access nodes (Neighbour_RBS_1, in step 110b; and Neighbour_RBS_2, in step 110c). The notification messages may comprise an indication of the accident, such as one or more of: a location of the accident; and a time (and date) of the accident. The notification messages may also comprise further information, such as one or more of: the nature and/or severity of the accident; a vehicle type of the vehicle involved in the accident; a propulsion type of the vehicle involved in the accident; an indication of the direction of travel of the vehicle involved in the accident; and an indication of a speed of travel of the vehicle involved in the accident.

FIG. 2 shows separate notification messages being sent by the alert service 20 to each radio access node in steps 110a, 110b, and 110c. However, in alternative embodiments, the alert service 20 may transmit a single notification message, even if warning messages are required devices in neighbouring cells. For example, a single notification message may be transmitted to the radio access node serving the cell in which the accident occurred, with an instruction that the radio access node should transmit further notification messages to its neighbouring radio access nodes directly (e.g. via a direct interface such as the X2 interface).

In step 112, each radio access node transmits warning messages to one or more wireless devices in the cells which they serve. Thus, in step 112a, the radio access node RBS transmits a warning message to one or more devices in the cell in which the accident occurred. In step 112b, the first neighbouring radio access node Neighbour_RBS_1 transmits a warning message to one or more devices in its cell; and in step 112c, the second neighbouring radio access node Neighbour_RBS_2 transmits a warning message to one or more devices in its cell. Warning signals may be transmitted only to a subset of the devices in the cell (as defined in step 108, and addressed for example by a multicast address), or broadcast to all devices in the cell.

The warning signals may comprise an indication of the accident, such as one or more of: a location of the accident; and a time (and date) of the accident. This information enables the wireless devices to take appropriate action. For example, a warning may be displayed to a user of the device so that the user can take appropriate action such as braking, or seeking an alternative route. Alternatively, or additionally, the accident information may be passed to a mapping or routing application running on the device, so that the application can alter the proposed route as appropriate.

The warning signals may also comprise further information, such as one or more of: the nature and/or severity of the accident; a vehicle type of the vehicle involved in the accident; a propulsion type of the vehicle involved in the accident; an indication of the direction of travel of the vehicle involved in the accident; and an indication of a speed of travel of the vehicle involved in the accident. This information may be particularly useful in embodiments where the alert service 20 does not identify a subset of devices to receive the warning signal but instead initiates broadcast of a warning signal to all devices within a particular cell. The additional information may thus enable the wireless devices themselves to determine one or more of: the severity of the accident, and whether or not the device is moving towards the accident or away from it. If moving away from the accident, the device may determine that no action is required to warn the user or alter a proposed route, etc.

Thus the alert service 20 takes advantage of established, standardized methods for the reporting of accidents to automatically warn other users in the vicinity of the accident. FIG. 2 showed an implementation in which the alert service is located in a node such as a core network node.

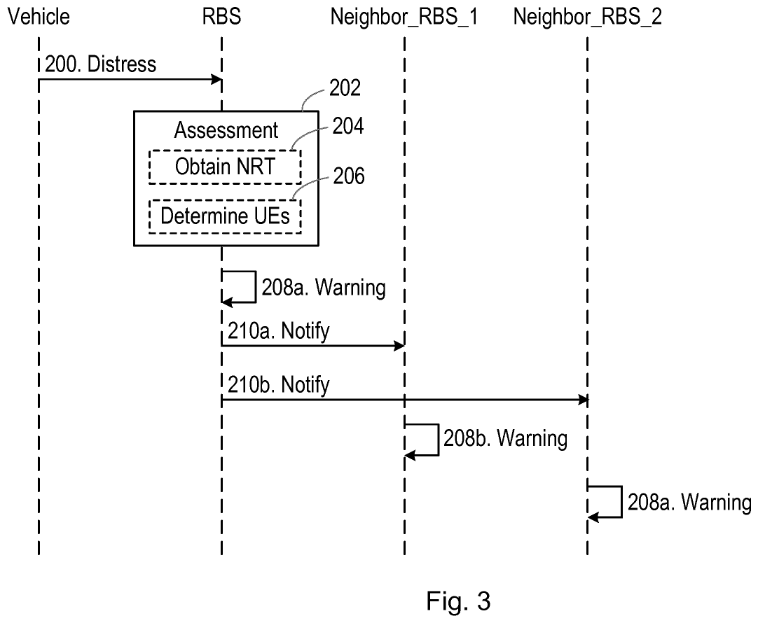

FIG. 3 is a signalling diagram of a method according to further embodiments of the disclosure, in which the alert service 20 is implemented within a radio access node (specifically, the radio access node that receives the distress signal from the vehicle that is involved in the accident). The method is otherwise substantially similar to that described above with respect to FIG. 2.

Thus in step 200, the vehicle V4 is involved in a road accident, and the safety system within the vehicle detects the accident and automatically transmits a distress signal that is received by the radio access node (RBS) serving the cell in which the accident occurred. In step 202, the radio access node RBS assesses the distress signal. For example, it may determine the severity of the accident as described above with respect to step 104. In step 204, particularly if devices within one or more neighbouring cells are to be warned of the accident, the radio access node may access its NRT (as described above with respect to step 106). In step 206, the radio access node may determine the devices that are to receive warning messages (as described above with respect to step 108).

As the alert service is implemented within the radio access node serving the cell in which the accident took place (in this embodiment), the radio access node is in a position to immediately transmit warning messages to one or more devices in its cell (i.e., before notifying one or more neighbouring cells). Thus, in step 208a, the radio access node RBS transmits warning signals to one or more devices in its cell (as described above with respect to step 112a). Warning signals may be transmitted to all devices within the cell (i.e. broadcasted), or a subset (i.e. only vehicles, only vehicles travelling towards the accident, etc).

In steps 210a and 210b, the radio access node RBS transmits notification messages to its neighbouring radio access nodes, for example, over a direct interface (such as the X2 interface). The notification messages may be substantially the same as those described above with respect to step 110. In steps 208b and 208c, these radio access nodes transmit warning signals to one or more devices in their respective cells.

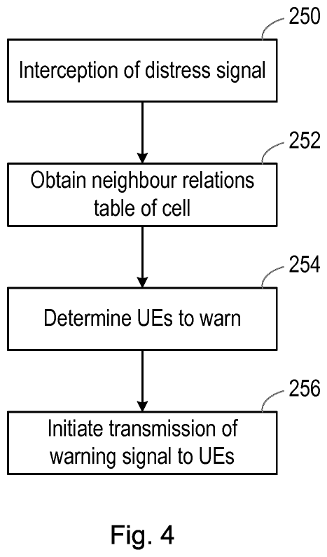

FIG. 4 is a flow chart of a method according to embodiments of the disclosure, carried out within an alert service 20. The alert service 20 may be implemented in a core network node (e.g. as described above with respect to FIG. 2), or a radio access node (e.g. as described above with respect to FIG. 3).

In step 250, the alert service intercepts a distress signal or is informed that a distress signal has been received by another node, such as the radio access nodes described above. Further detail regarding this step may be found above, in steps 100 and 200 of FIGS. 2 and 3 respectively.

In step 252, the alert service optionally obtains the neighbour relations table (NRT) of the cell in which the accident occurred. Further detail regarding this step may be found above, in steps 106 and 204 of FIGS. 2 and 3 respectively.

In step 254, the alert service optionally determines which wireless devices should be warned about the accident. Further detail regarding this step may be found above, in steps 108 and 206 of FIGS. 2 and 3 respectively.

In step 256, the alert service initiates transmission of warning signals, containing an indication of the accident, to one or more wireless devices (e.g. the devices determined in step 254). For example, transmission of warning signals may be initiated by the alert service transmitting the warning signals itself (e.g. when the alert service is implemented within a radio access node, as shown in step 208a), or by transmitting one or more notification signals to radio access nodes with instructions for those radio access nodes to transmit appropriate warning signals (as shown in steps 110a, 110b, 110c, 210a and 210b).

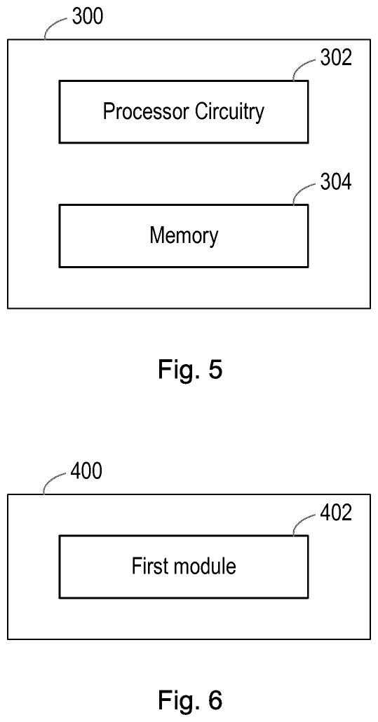

FIG. 5 is a schematic diagram of a network node 300 according to embodiments of the disclosure. The network node 300 may be suitable for carrying out the method shown in FIG. 4, and may thus be suitable for implementing the alert service 20 described above. For example, the network node 300 may be a radio access node (such as a radio base station, eNode B, etc), or a core network node.

The network node 300 comprises processing circuitry 302 and a memory 304. The memory 304 contains instructions executable by the processing circuitry 302, whereby the network node 300 is operative to: responsive to reception of a distress signal by a radio access node, the distress signal generated automatically by a vehicle involved in an accident, initiate transmission, by the radio access node, of a warning signal containing an indication of the accident to one or more wireless devices.

The network node 300 may further comprise one or more interfaces (not illustrated) for communicating with other nodes of the network. For example, the node 300 may comprise one or more antennas and transceiver circuitry, for transmitting and receiving wireless signals. The node 300 may comprise a wired interface, for transmitting and receiving signals over a wire.

FIG. 6 is a schematic diagram of a network node 400 according to further embodiments of the disclosure. The network node 400 may be suitable for carrying out the method shown in FIG. 4, and may thus be suitable for implementing the alert service 20 described above. For example, the network node 400 may be a radio access node (such as a radio base station, eNode B, etc), or a core network node.

The network node 400 comprises a first module 402 configured to, responsive to reception of a distress signal by a radio access node, the distress signal generated automatically by a vehicle involved in an accident, initiate transmission, by the radio access node, of a warning signal containing an indication of the accident to one or more wireless devices.

The network node 400 may further comprise one or more interface modules (not illustrated) for communicating with other nodes of the network. For example, the node 300 may comprise a transceiver module, coupled to one or more antenna, for transmitting and receiving wireless signals. The node 300 may comprise a wired interface module, for transmitting and receiving signals over a wire.

The disclosure thus provides methods, apparatus and computer-readable mediums that enable warning signals to be transmitted to wireless devices in the vicinity of a vehicular accident. Embodiments of the disclosure make use of the distress signals generated by automated safety systems within vehicles to generate corresponding warning and notification messages to radio access nodes and wireless devices served by those radio access nodes. Thus users of the wireless devices can be informed of the accident and take appropriate action, such as diverting to a different route or initiating early braking. In certain embodiments, only a subset of the available wireless devices are informed of the accident, reducing the network traffic associated with the notification and warning messages.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a network node of a wireless telecommunication system, the method comprising:
responsive to reception of a distress signal by a radio access node, the distress signal generated automatically by a vehicle involved in an accident, initiating transmission, by the radio access node, of a warning signal containing an indication of the accident to one or more wireless devices.

2. The method of claim 1, further comprising:
initiating transmission, by one or more neighbouring radio access nodes that neighbour the radio access node, of the warning signal to one or more further wireless devices.

3. The method of claim 2, further comprising:
obtaining a neighbour relations table of the radio access node.

4. The method of claim 1, wherein the indication of the accident comprises one or more of: a location of the accident; and a time of the accident.

5. The method of claim 4, wherein the indication of the accident further comprises one or more of: a vehicle type of the vehicle involved in the accident; a propulsion type of the vehicle involved in the accident; an indication of the direction of travel of the vehicle involved in the accident; an indication of a speed of travel of the vehicle involved in the accident.

6. The method of claim 1, wherein the step of initiating transmission of the warning signal to one or more wireless devices comprises initiating broadcast of the warning signal by the radio access node.

7. The method of claim 1, further comprising:
identifying wireless devices that are integrated within vehicles,
wherein the step of initiating transmission of the warning signal to one or more wireless devices comprises initiating transmission of the warning signal to the wireless devices integrated within vehicles.

8. The method according to of claim 1, further comprising:
identifying wireless devices that are travelling towards a location of the accident,
wherein the step of initiating transmission of the warning signal to one or more wireless devices comprises initiating transmission of the warning signal to the wireless devices that are travelling towards the location of the accident.

9. The method of claim 1, wherein the network node is the radio access node.

10. The method of claim 1, wherein the network node is a core network node of the wireless telecommunication system.

11. A network node for a wireless telecommunication system, the network node comprising:
processor circuitry; and
a computer-readable medium coupled to the processor circuitry and storing code which, when executed by the processor circuitry, causes the network node to:
responsive to reception of a distress signal by a radio access node, the distress signal being generated automatically by a vehicle involved in an accident, initiate transmission, by the radio access node, of a warning signal containing an indication of the accident to one or more wireless devices.

12. The network node of claim 11, wherein the computer-readable medium further comprises code which, when executed by the processor circuitry, causes the network node to:
initiate transmission, by one or more neighbouring radio access nodes that neighbour the radio access node, of the warning signal to one or more wireless devices.

13. The network node of claim 12, wherein the computer-readable medium further comprises code which, when executed by the processor circuitry, causes the network node to:
obtain a neighbour relations table of the radio access node.

14. The network node of claim 11, wherein the indication of the accident comprises one or more of: a location of the accident; and a time of the accident.

15. The network node of claim 14, wherein the indication of the accident further comprises one or more of: a vehicle type of the vehicle involved in the accident; a propulsion type of the vehicle involved in the accident; an indication of the direction of travel of the vehicle involved in the accident; and an indication of a speed of travel of the vehicle involved in the accident.

16. The network node of claim 11, wherein the network node is configured to initiate transmission of the warning signal to one or more wireless devices by initiating broadcast of the warning signal by the radio access node.

17. The network node of claim 11, wherein the computer-readable medium further comprises code which, when executed by the processor circuitry, causes the network node to:
identify wireless devices that are integrated within vehicles,
wherein the network node is configured to initiate transmission of the warning signal to one or more wireless devices by initiating transmission of the warning signal to the wireless devices integrated within vehicles.

18. The network node of claim 11, wherein the computer-readable medium further comprises code which, when executed by the processor circuitry, causes the network node to:
identify wireless devices that are travelling towards a location of the accident,
wherein the network node is configured to initiate transmission of the warning signal to one or more wireless devices by initiating transmission of the warning signal to the wireless devices that are travelling towards the location of the accident.

19. The network node of claim 11, wherein the network node is the radio access node.

20. (canceled)

21. A computer program product comprising a non-transitory computer-readable medium storing code which, when executed by processor circuitry of a network node, causes the network node to:
responsive to reception of a distress signal by a radio access node, the distress signal being generated automatically by a vehicle involved in an accident, initiate transmission, by the radio access node, of a warning signal containing an indication of the accident to one or more wireless devices.

22-30. (canceled)
